(19) United States
(12) Patent Application Publication
(10) Pub. No.: US 2018/0247552 A1
(43) Pub. Date: Aug. 30, 2018

(54) STUDY-SUPPORT SYSTEM, AND ASSOCIATED DEVICES AND METHODS

(71) Applicant: Compass, Inc., Tokyo (JP)

(72) Inventors: Genki JINNO, Tokyo (JP); Masaki OGAWA, Tokyo (JP)

(73) Assignee: Compass, Inc., Tokyo (JP)

(21) Appl. No.: 15/758,717

(22) PCT Filed: Sep. 8, 2016
(86) PCT No.: PCT/JP2016/076475

§ 371 Date: Mar. 8, 2018

(30) Foreign Application Priority Data
Sep. 8, 2015 (JP) 2015-176765
Dec. 21, 2015 (JP) 2015-248831

(51) Int. Cl. G09B 7/04; G06Q 50/20

(52) U.S. Cl. CPC G09B 7/04; G06N 99/005; G06Q 50/20

(57) ABSTRACT

A study-support system includes a question-supply unit configured to supply a question for learning to a user through a display; a creating unit configured to create an electronic memo based on a memo entry by the user through an input device that is integrated with or attached to the display; and a determining unit configured to determine a new question to be supplied based on the electronic memo that includes a memo entered by the user during a process of solving the question created in the creating unit. The question-supply unit supplies a question determined in the determining unit.

### CROSS-REFERENCE TO RELATED APPLICATION

This international application claims the benefit of Japanese Patent Application No. 2015-176765 filed Sep. 8, 2015 in the Japan Patent Office and Japanese Patent Application No. 2015-248831 filed Dec. 21, 2015 in the Japan Patent Office, and the entire disclosure of Japanese Patent Application No. 2015-176765 and Japanese Patent Application No. 2015-248831 is incorporated herein by reference.

### TECHNICAL FIELD

The present disclosure relates to a study-support system that supports a user's learning, and also relates to devices, computer programs, storage mediums, and methods associated with the study-support system.

### BACKGROUND ART

An electronic notebook that displays a base image on its display and, in response to a memo entry on the base image with a stylus, displays the entered memo on the display has been conventionally known (see, Patent Document1). For example, a window to display a question and a window to display an answer are laid out on the base image. In addition, a system that allows a teacher to see a memo entered by a learner has also been known (see, Patent Document2). In this system, the memo entered to the learner's terminal by the learner is transmitted to a server.

### PRIOR ART DOCUMENTS

### Patent Documents

Patent DocumeNT1: Japanese Unexamined Patent Application Publication No. 2013-145265

Patent DocumeNT2: Japanese Unexamined Patent Application Publication No. 2013-156788

### SUMMARY OF THE INVENTION

### Problems to be Solved by the Invention

Questions provided by a study-support system that supplies questions to a learner through an electronic device can be flexible compared with paper-based study support systems. To increase learning efficiency of the learner, the study-support system can selectively provide questions that, for example, have been incorrectly solved by the learner in the past questions.

Increase in learning efficiency is nevertheless limited when questions to the learner are determined based merely on whether the learner's answer to the past questions were right or wrong. Incorrectly solved questions include questions that are incorrectly solved due to careless errors of the learner. Incorrectly solved questions also include questions that are submitted as blank with no answers due to lack of the learner's comprehension of elementary knowledge. In addition, incorrectly solved questions also include questions that the lerner tried to solve but incorrectly solved due to the learner's incomplete comprehension of the knowledge required for the solution. Conventional systems have experienced limits in increasing learning efficiency since these systems decide questions to be supplied to the learner regardless of the aforementioned variations that lead to incorrect answers.

Desirably, one aspect of the present disclosure provides a system that allows a user to learn efficiently.

### Means for Solving the Problems

A study-support system according to one aspect of the present disclosure comprises a question-supply unit; a creating unit; and a determining unit. The question-supply unit supplies a question for learning to a user. For example, the question-supply unit supplies a question for learning to the user through a display.

The creating unit creates an electronic memo in response to a memo entry by the user through an input device. The input device may be, for example, integrated with or attached to the display.

The determining unit determines a new question to be supplied based on the electronic memo that includes a memo entered by the user during a process of solving the question. The question-supply unit supplies a question that is thus determined in the determining unit.

In one aspect the present disclosure, the process of solving the question includes steps the user takes until the user decides an answer. Thus, the electronic memo includes the memo entered by the user before reaching the solution; in some cases, an obtained answer may also be included in the electronic memo. The memo entered during the process of solving the question shows characteristics that correspond to a level of proficiency or level of understanding of the user. For example, the memo shows characteristics of an incorrect question solving style that correspond to the level of proficiency or the level of understanding of the user. Consequently, one aspect of the present disclosure may supply a study-support system that can supply a suitable question that meets the level of proficiency or level of understanding of the user.

According to one aspect of the present disclosure, the determining unit may determine the new question such that a different question is supplied afresh from the question-supply unit depending on differences in the process of solving the question.

According to one aspect of the present disclosure, the determining unit may use the categorizer to determine the new question to be supplied by the question-supply unit based on the electronic memo. In response to an input of the electronic memo and question identification data, the categorizer may output target-question information, which is information pertaining to a question that should be supplied or a question that should be a candidate of a question to be supplied.

According to one aspect of the present disclosure, the categorizer may be a machine learning-based categorizer. The categorizer prepares data sets as training data. Each data set includes the electronic memo and the question identification data as input and the aforementioned target-question information as output. The categorizer may be created by causing a machine learning system to learn the categorizer based on these training data. Those who design or manage the system can analyze characteristics of the memo that is entered during the process of solving the question and create the training data, in which questions corresponding to a level of proficiency or a level of understanding of the user are set to a question that should be supplied or a question that should be a candidate of a question to be supplied. Those who design or manage the system can obtain a suitable categorizer by causing the machine learning system to execute an operation to create the categorizer based on these training data.

According to one aspect of the present disclosure, the determining unit may input to the categorizer the electronic memo that is created during the process of solving the question along with the question identification data and then determine a new question based on the output (target-question information) from the categorizer. For example, the determining unit can supply the aforementioned new question, which is determined by the categorizer, to the question-supply unit.

In addition, those who design or manage the system may create a more suitable categorizer by creating training data and causing the machine learning system to execute the operation to create the categorizer based on this training data; the training data includes, as an input, the electronic memo and the question identification data, and at least one of the information that shows an obtained answer to the question or the information that shows whether the obtained answer was right or wrong. In this case, the categorizer can output the target-question information based on a set of input information that comprises the electronic memo and the question identification data, and at least one of the information that shows an obtained answer to the question or the information that shows whether the obtained answer was right or wrong.

Those who design or manage the system may create a more suitable categorizer by creating training data and causing the machine learning system to execute the operation to create the categorizer based on this training data; the training data includes, as an input, the electronic memo and the question identification data, and at least one of information that shows solving time or information that shows a level of proficiency or a level of understanding of the user. According to one aspect of the present disclosure, the categorizer may output the target-question information based on a set of input information that comprises the electronic memo and the question identification data, and at least one of the information that shows the solving time or the information that shows a level of proficiency or a level of understanding of the user.

According to one aspect of the present disclosure, a computer program may cause a computer to function as at least one of the question-supply unit, the creating unit, or the determining unit of the aforementioned study-support system. The program, which causes a computer to function as at least one of the question-supply unit, the creating unit, or the determining unit, can be stored in a computer readable non-transitory storage medium. One aspect of the present disclosure may provide a study-support system that comprises at least one processor, and at least one memory; the at least one memory stores a computer program that causes the at least one processor to function as the question-supply unit, the creating unit, and the determining unit.

One aspect of the present disclosure may provide an electronic device that comprises a question-supply unit configured to supply a question for learning, a creating unit configured to create an electronic memo in response to a memo entry by a user, and a transmitting unit configured to transmit the electronic memo to a server.

The question-supply unit of the electronic device may supply the question for learning to the user through the display. The creating unit may create the electronic memo in response to the memo entry by the user through an input device integrated with or attached to the display. The transmitting unit of the electronic device may transmit, to the server through a communication device, the electronic memo that is created in the creating unit including a memo entered by the user during a process of solving the question.

The server may determine a question to be supplied by the electronic device based on this electronic memo and returns information of the determined question to the electronic device. The server may use the aforementioned categorizer to determine a question to be supplied by the electronic device. The server may include one or more servers.

Such a configuration of the server may allow the question-supply unit of the electronic device to supply the question for learning based on the information received from the server through the communication device. This electronic device may cooperate with the server and provide the user with an access to the same functions as the aforementioned study-support system.

One aspect of the present disclosure may provide a computer program that is configured for causing a computer to function as at least one of the question-supply unit, the creating unit, or the transmitting unit of the aforementioned electronic device. This program may be stored in a computer readable non-transitory storage medium. The electronic device may be, for example, a general-purpose device, such as a portable computer and a tablet, in which a computer program can be installed.

One aspect of the present disclosure may provide a server that comprises an obtaining unit configured to obtain an electronic memo that is created based on a memo entry by a user in an electronic device for supplying a question for learning to the user; a determining unit configured to determine a question to be supplied by the electronic device based on the electronic memo obtained by the obtaining unit; and an information supplying unit configured to transmit, to the electronic device, information of the question determined in the determining unit. The electronic memo may include a memo entered by the user during a process of solving the question.

One aspect of the present disclosure may provide a computer program that is configured for causing a computer to function as at least one of the obtaining unit, the determining unit, or the information supplying unit of the aforementioned server. The program may be stored in a computer readable non-transitory storage medium. One aspect of the present disclosure may provide a system that comprises at least one processor, and at least one memory; the at least one memory stores the program that causes the at least one processor to function as the obtaining unit, the determining unit, and the information supplying unit. According to one aspect of the present disclosure, two or more servers may cooperate to function as the obtaining unit, the determining unit, and the information supplying unit.

One aspect of the present disclosure may further provide a system to create or update the aforementioned categorizer. In other words, one aspect of the present disclosure may provide an information processing device that comprises a first obtaining unit configured to obtain an electronic memo and question identification data; a second obtaining unit configured to obtain target-question information that corresponds to the electronic memo and the question identification data; and a control unit configured to cause a machine learning system to learn the categorizer using training data, which is based on the information obtained by the first obtaining unit and the second obtaining unit.

The first obtaining unit of this information processing device may obtain the electronic memo that is created based on a memo entry by a user in an electronic device, which supplies a question for learning to the user, during a process of solving the question, and the question identification data that corresponds to the electronic memo. The first obtaining unit may obtain the electronic memo and the question identification data from the electronic device, for example, by communications.

The second obtaining unit of the information processing device may obtain the target-question information pertaining to a question that should be supplied or a question that should be a candidate of a question to be supplied to the user whose level of proficiency or level of understanding corresponds to the electronic memo and the question identification data obtained by the first obtaining unit. The second obtaining unit may obtain the target-question information from an individual through, for example, an input device. A person who inputs the information may be an individual who belongs to those who manage the study-support system. For example, the person who inputs the information can determine a question that should be supplied or a question that should be a candidate of a question to be supplied based on an analysis of characteristics of the memo that is entered by the user during the process of solving the question and included in the electronic memo.

The control unit of the information processing device may input data sets to the machine learning system as the training data. Each data set includes the electronic memo and the question identification data obtained by the first obtaining unit as input, and the target-question information obtained by the second obtaining unit as output.

In response to the input of the electronic memo and the question identification data, the machine learning system may create or update the categorizer that outputs the target-question information, which is the information pertaining to a question that should be supplied or a question that should be a candidate of a question to be supplied, based on the inputted training data. To create or update the categorizer may be to set or update a parameter that defines the relationship between the input and the output of the categorizer based on the training data.

As mentioned above, the control unit of the information processing device may cause the machine learning system to create or update the aforementioned categorizer by inputting the training data to the machine learning system.

One aspect of the present disclosure may provide a machine learning system that comprises the same first obtaining unit and second obtaining unit as those of the information processing device; and a machine learning unit configured to create or updates the categorizer by machine learning on data sets as the training data. Each data set comprises input that includes the electronic memo and the question identification data obtained by the first obtaining unit, and output that includes the target-question information obtained by the second obtaining unit. The categorizer outputs the target-question information in response to the input of the electronic memo and the question identification data.

One aspect of the present disclosure may provide a method of creating and updating the categorizer. The method comprises obtaining the electronic memo and the question identification data; creating or obtaining the target-question information; and creating or updating the categorizer by using data sets as training data. Each data set includes the obtained electronic memo and question identification data as mentioned above as input and the created or obtained target-question information as mentioned above as output. This method may be carried out on a computer.

One aspect of the present disclosure may provide a method that comprises supplying a question for learning to the user through a display; creating an electronic memo based on a memo entry by the user through an input device; and determining a new question to be supplied based on the electronic memo created during a process of solving the question. This method may be carried out on a computer. The aforementioned configuration for each of the systems and devices should help to understand technical ideas for the methods, computer programs, and storage mediums corresponding to these systems and devices.

### BRIEF DESCRIPTION OF THE DRAWINGS

FIG. 1 is a block diagram showing a configuration of a study-support system;

FIG. 2 is a diagram showing functions performed by a controller in a user terminal;

FIG. 3A is a diagram showing a layout on a question window;

FIG. 3B is a diagram showing a form of displaying a memo window;

FIG. 4 is a diagram showing configurations of a server, a database management device, a question-supply control device, and a training-data creating device;

FIG. 5 is a flowchart showing processes executed in the server;

FIG. 6 is a diagram showing a configuration of database in the database management device;

FIG. 7A is a diagram explaining status values for an answer;

FIG. 7B is a diagram explaining status values for an answer;

FIG. 8 is a diagram showing functions performed by a controller in the question-supply control device;

FIG. 9A is an explanatory diagram of an example of an answer;

FIG. 9B is an explanatory diagram of an example of an answer; and

FIG. 10 is a flowchart showing processes executed in the training-data creating device.

### MODE FOR CARRYING OUT THE INVENTION

Hereinafter, an example embodiment of the present disclosure will be described with reference to the drawings.

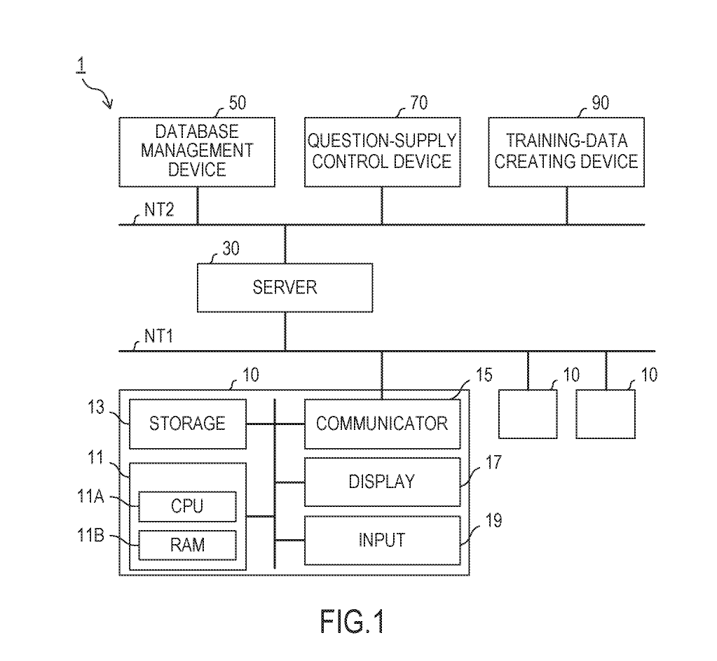

A study-support system 1 of the present embodiment as shown in FIG. 1 comprises user terminals 10; a server 30; a database management device 50; a question-supply control device 70; and a training-data creating device 90. The server 30 is designed to communicate with the user terminals 10 via wide area network NT1. The database management device 50, the question-supply control device 70, and the training-data creating device 90 are coupled to network NT2 in the back end along with the server 30. The database management device 50, the question-supply control device 70, and the training-data creating device 90 are different (additional) servers that cooperate with the server 30 to perform functions pertaining to study support.

The user terminals 10 cooperate with the server 30 to supply questions for learning. Examples of the user terminals 10 are electronic devices such as personal computers, tablets, and smartphones owned by the user. A general user terminal 10 comprises a controller 11; a storage 13; a communicator 15; a display 17; and an input 19.

The controller 11 comprises a CPU 11A, and a RAM 11B and integrally controls the user terminal 10. The CPU 11A executes a process in accordance with a program stored in the storage 13. The RAM 11B is used as a working memory when the CPU 11A executes the process. Hereinafter, the process executed by the CPU 11A will be explained as being executed by the controller 11.

The storage 13 stores various programs and data. The storage 13 comprises a flash memory or a hard disc device. The communicator 15 is designed to communicate with external devices. The communicator 15 is designed to communicate with devices within the wide area network NT1, including the server 30, via a cellular network for example. Alternatively, the communicator 15 is designed to communicate with devices within the wide area network NT1 via a wired LAN or a wireless LAN.

The display 17 displays various windows to a user. The display 17 comprises, for example, a liquid crystal display. The input 19 receives an input manipulation by the user and inputs a corresponding manipulation signal to the controller 11.

The input 19 may be a touch panel that is integrated with or attached to the display 17. The touch panel receives a touch action and a memo entry on a window displayed on the display 17 and inputs corresponding manipulation signals to the controller 11. The input 19 may comprise an additional input device that allows the user to, at least virtually, give a click action (or touch action) or a memo entry on a window displayed on the display 17. For example, the input 19 may comprise a pointing device or a stylus for a tablet.

The user terminal 10, which has the aforementioned hardware configuration, has an application program installed that allows the user terminal 10 to cooperate with the server 30 to supply questions for learning; the application program is stored in the storage 13.

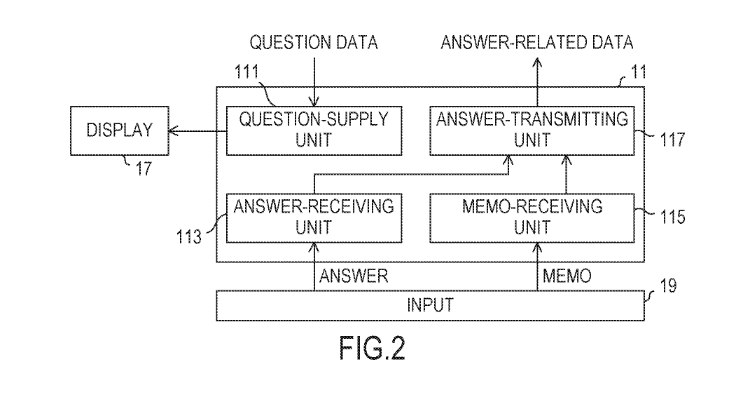

The controller 11 executes a process in accordance with this application program to cooperate with the server 30 to supply a question that matches a level of proficiency or a level of understanding of the user. Functions provided by the controller 11 will be explained with reference to FIG. 2.

As shown in FIG. 2, the controller 11 functions as a question-supply unit 111, an answer-receiving unit 113, a memo-receiving unit 115, and an answer-transmitting unit 117 by executing the process in accordance with the application program.

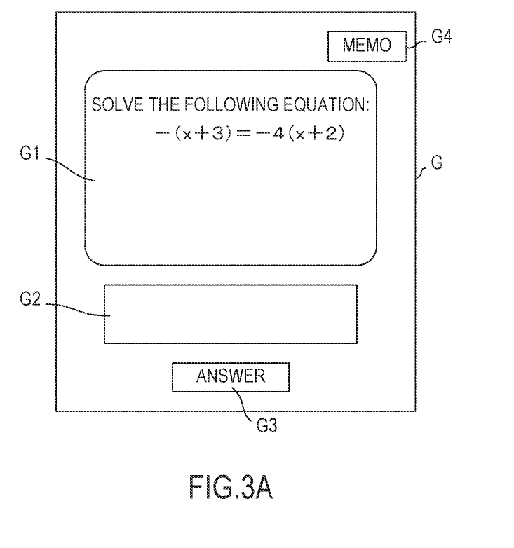

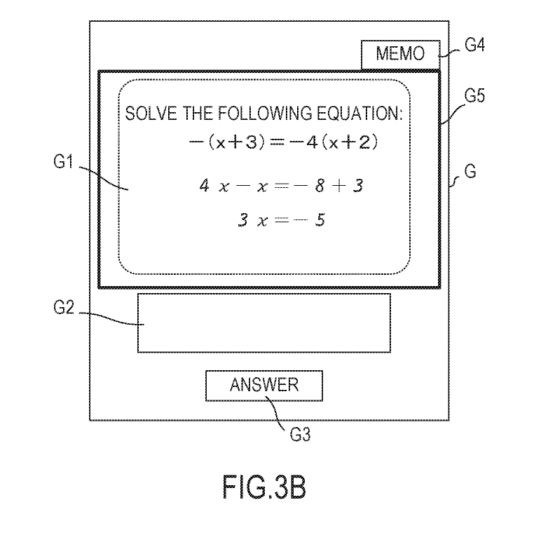

The question-supply unit 111 controls the display 17 to display a question window G (see FIG. 3A) which is based on question data provided by the server 30 on the display 17. This display control causes the question-supply unit 111 to supply a question, provided by the server 30, to the user.

More specifically, activation of the application program triggers the question-supply unit 111 to transmit user identification data to the server 30 via the communicator 15 and to establish connection with the server 30. In response to an input of a manipulation signal by the user through the input 19 to designate a desired group of questions, the question-supply unit 111 transmits to the server 30 a designation command to designate the group of questions. The group of questions is designated from groups that are categorized relatively roughly, for example, as “equations”, “graphs”, and “figures”, or as “middle school first grader math”, and “middle school third grader science”.

In response to the designation command, the server 30 transmits question data of a question in the designated group to the user terminal 10 that originated the designation command. The question data comprises a question ID and data of question sentence corresponding to the question for display. The question ID is an identification code unique to each question and corresponds to identification information of each question. The question ID may be defined to include a category code of the question. For example, the question ID may comprise multiple-digit numbers, in which a higher-order digit represents the general category of the question, a middle-order digit represents a subcategory of the question within the general category, and a lower-order digit represents an identification number of the question in the subcategory. Such an allocation of numbers in the question ID causes similar questions to have close numbers. The question data may comprise correct-answer data, which shows the correct answer to the question, to determine whether the answer in the user terminal 10 is right or wrong. The question data may also comprise expository data to give an exposition of the question to the user. The question data may also comprise hint data to provide the user with a hint that leads to the correct answer.

Each time the question-supply unit 111 receives the question data from the server 30, the question-supply unit 111 causes the display 17 to display the question window G, which includes the corresponding question sentence, based on the received question data. As shown in FIG. 3A, the question window G that is displayed on the display 17 includes a question display box G1 and an answer box G2.

The answer-receiving unit 113 receives an input manipulation by the user through the input 19 in the answer box G2 on the question window G. In response to an answer-deciding operation which is a pressing manipulation through the input 19 on an “answer” icon G3 in the question window G, the answer-receiving unit 113 performs text recognition of the answer entered by the user in the answer box G2 and create answer data that include the answer that has undergone the text recognition.

The answer-receiving unit 113 may determine whether the answer is right or wrong as a result of performing the text recognition and control the display 17 to display in the question window G whether the answer is right or wrong as well as the correct answer. The question window G may also display expository texts of the question in addition to the correct answer. The aforementioned answer data may include the question ID of the question that is answered, and information that shows whether the answer was right or wrong. The answer data may also include a solving time and date and time of the answer. The solving time corresponds to the duration of time from when a question is supplied (displayed) until the answer-deciding operation is performed. The date and time of answer correspond to the date and time the answer-deciding operation is performed.

During a period of time from when the question window G is displayed until the answer of the user is decided by a pressing manipulation on the “answer” icon G3, the memo-receiving unit 115 receives a display command from the user to display a memo pad window G5. The memo-receiving unit 115 determines that the display command to display the memo pad window G5 is entered in response to a pressing manipulation on a memo pad request icon G4, shown in FIG. 3A, through the input 19 when the memo pad window G5 is not displayed.

As shown in FIG. 3B, the memo-receiving unit 115 arranges the memo pad window G5, a transparent layer that virtually functions as a transparent sheet of paper, on top of the question display box G1 when the memo receiving unit 115 determines that the display command to display the memo pad window G5 is entered.

In response to a memo entry on the memo pad window G5 through the input 19, the memo-receiving unit 115 displays penstrokes that correspond to the memo entry on top of the question display box G1, and simultaneously creates memo-image data of the penstrokes and temporarily stores the memo-image data in the RAM 11B. The memo-image data may include coordinates of the penstrokes in chronological order in accordance with the movement of a stylus, or may be raster image data that shows the penstrokes in a raster image. The memo-image data may include a result of text recognition of the penstrokes. In other words, the memo-image data may represent the entered memo by one or a combination of the following: image information of the penstrokes, the chronological positional information of the penstrokes, or text information of the penstrokes. The memo-image data may include information of the penstrokes of a memo that is erased from the memo pad window G5 by an erasing action (eraser function) by the user. The memo-receiving unit 115 closes the memo pad window G5 in response to the second pressing manipulation on the memo pad request icon G4 through the input 19 when the memo pad window G5 is displayed. The memo-image data is nevertheless kept stored in the RAM 11B after the memo pad window G5 is closed.

The answer-transmitting unit 117 transmits answer-related data to the server 30 in response to a pressing manipulation on the “answer” icon G3 on the question window G. The answer-related data includes answer data created in the answer-receiving unit 113, the memo-image data created in the memo-receiving unit 115 in the process of solving the question, and the user ID that is the user identification data.

In addition to the answer data and the memo-image data, the answer-related data also includes log data pertaining to manipulations by the user. The log data corresponds to a list of manipulations by the user through the input 19 during a period of time from when the question is displayed until the answer-deciding operation is performed. The log data can be created in the answer-transmitting unit 117.

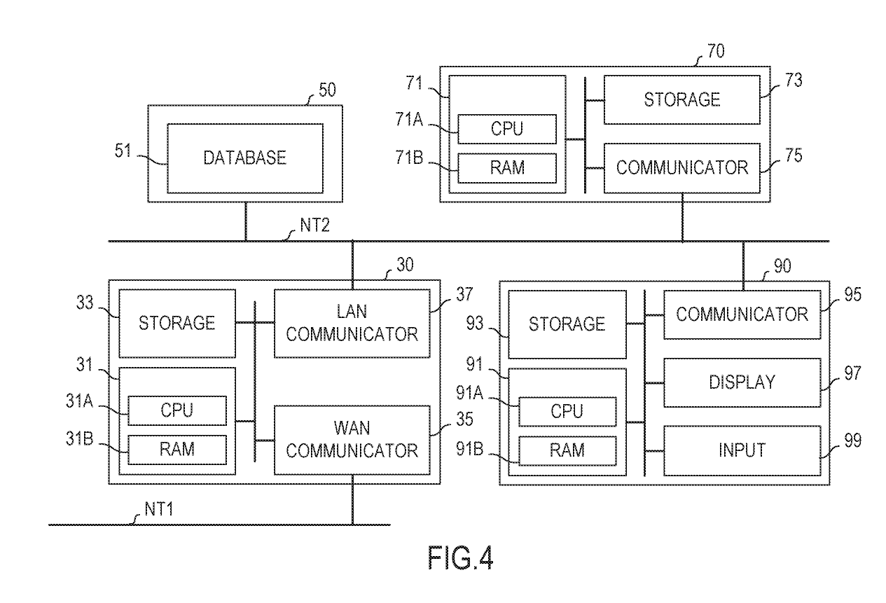

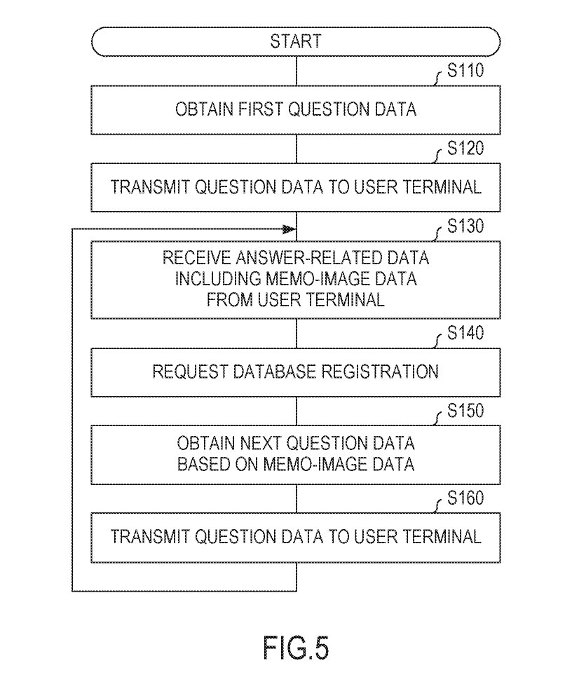

Configuration of the server 30 will be explained next with reference to FIG. 4 and FIG. 5. As shown in FIG. 4, the server 30 comprises a controller 31, a storage 33, a WAN communicator 35, and a LAN communicator 37. The controller 31 comprises a CPU 31A and a RAM 31B. The CPU 31A executes a process in accordance with a program stored in the storage 33. The RAM 31B is used as a working memory when the CPU 31A executes the process. Hereinafter, the process executed by the CPU 31A will be explained as being executed by the controller 31.

The WAN communicator 35 is designed to communicate with the user terminal 10 via the wide area network NT1. The LAN communicator 37 is designed to communicate with the database management device 50, the question-supply control device 70, and the training-data creating device 90 that are coupled to the network NT2 in the back end.

In response to activation of the aforementioned application program in a user terminal 10, the controller 31 in the server 30 identifies the user who corresponds to the user terminal 10 based on the user identification data transmitted from the user terminal 10 and executes a process to establish a connection with the user terminal 10.

The controller 31 then waits to receive, from the user terminal 10, a designation command to designate a group of questions. In response to receiving the designation command, the controller 31 starts a process as shown in FIG. 5 by transmitting a primary-question-request command to the question-supply control device 70 to obtain question data of the first question that belongs to the group of questions designated by the user terminal 10 from the question-supply control device 70 through the network NT2 (S110). The controller 31 then transmits the question data to the user terminal 10 (S120). The question that corresponds to the question data transmitted from the server 30 to the user terminal 10 is supplied to the user by the question-supply unit 111 on the display 17 of the user terminal 10.

After transmitting the question data, the controller 31 receives answer-related data that corresponds to the question data from the user terminal 10 via the WAN communicator 35 (S130). As described above, the answer-related data is transmitted to the server 30 from the answer-transmitting unit 117 in the user terminal 10 in response to the answer-deciding operation by the user.

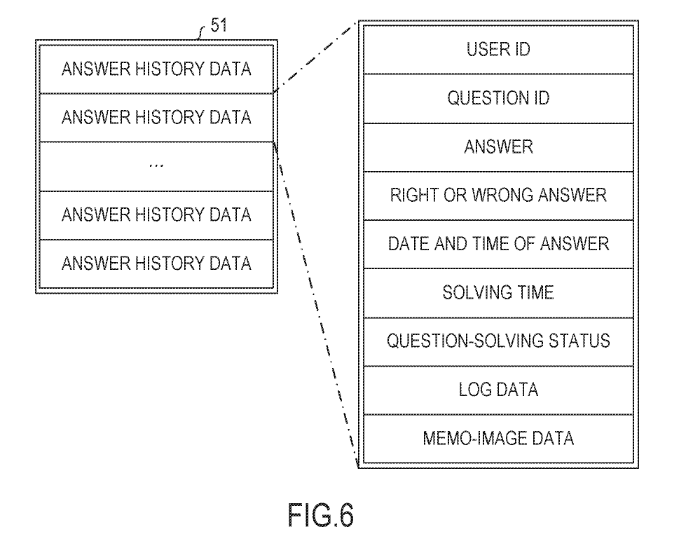

In response to receiving the answer-related data from the user terminal 10, the controller 31 requests the database management device 50 to register answer history data, which is based on the answer-related data (S140). The database management device 50 stores and manages a database 51 pertaining to the answer history data. In response to receiving a registration request command to register the answer history data from the server 30 via the network NT2, the database management device 50 registers the answer history data in the database 51 based on the answer-related data that is received along with the registration request command. As shown in FIG. 6, the database 51 comprises a collection of answer history data. The database management device 50 comprises a CPU, which is not shown, and a storage device. In the database management device 50, the CPU executes a process in accordance with a program stored in the storage device to enable the aforementioned process for registration.

As shown in FIG. 6, the answer history data in the database 51 comprises information representing the “user ID”, “question ID”, “answer”, “right or wrong answer”, “date and time of answer”, “solving time”, and “question-solving status”, along with the log data, and the memo-image data.

The “user ID” shown in the answer history data corresponds to the user identification data of the user who answered the question.

The “question ID” corresponds to the question identification data of the answered question. The “answer” in the answer history data precisely corresponds to the answer to the question entered by the user. The “right or wrong answer” corresponds to whether the “answer” shown in the answer history data was right or wrong. The “date and time of answer” corresponds to the date and time the answer is entered. The “solving time” corresponds to the duration of time taken by the user to solve the question. The “question-solving status” corresponds to a digitized value of the user's level of proficiency or level of understanding of the question.

The answer-related data the server 30 receives from the user terminal 10 (S130) comprises information representing the “user ID”, the “question ID”, the “answer”, the “right or wrong answer”, the “date and time of answer”, and the “solving time” and also comprises the log data and the memo-image data.

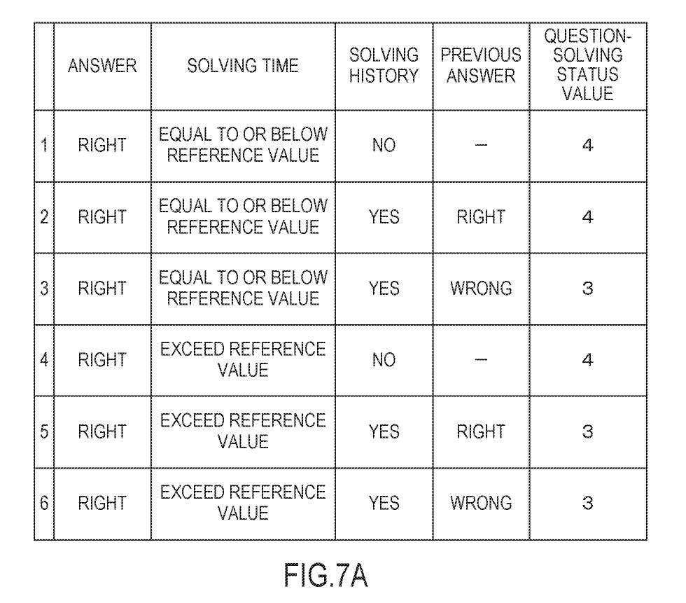

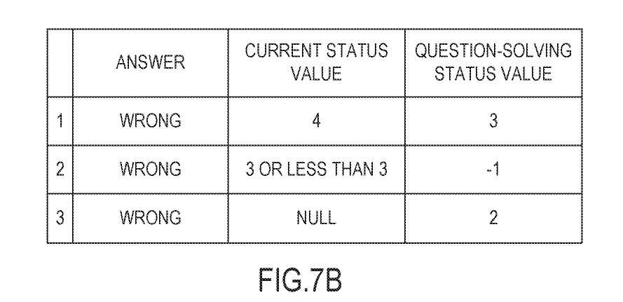

The database management device 50 can consequently extract, from the answer-related data, the answer history data registered in the database 51, except for the “question-solving status”. The database management device 50 can determine a value of the question-solving status based on tables shown in FIG. 7A and FIG. 7B by the parameter of the right or wrong answer; the solving time; whether the user has a history of solving the same question; and whether the previous answer to the same question was right or wrong.

Each time a question is solved in the user terminal 10, the user terminal 10 transmits the answer-related data to the server 30. When registering the answer history data, which is based on the corresponding answer-related data, in the database 51 in response to the registration request command from the server 30, the database management device 50 determines the value of the question-solving status to write in the answer history data as explained below.

As shown in the first row in the table of FIG. 7A, the database management device 50 determines that the question-solving status has value four if the present answer is correct; the present solving time is equal to or below a reference value; and the user has no history of solving the same question.

As shown in the second row in the table of FIG. 7A, the database management device 50 determines that the question-solving status has value four if the present answer is correct; the solving time is equal to or below the reference value; the user has a history of solving the same question; and the previous answer was correct.

As shown in the third row in the table of FIG. 7A, the database management device 50 determines that the question-solving status has value three if the present answer is correct; the solving time is equal to or below the reference value; the user has a history of solving the same question; and the previous answer was incorrect.

As shown in the fourth row in the table of FIG. 7A, the database management device 50 determines that the question-solving status has value four if the present answer is correct; the solving time exceeds the reference value; the user has no history of solving the same question.

As shown in the fifth row in the table of FIG. 7A, the database management device 50 determines that the question-solving status has value three if the present answer is correct; the solving time exceeds the reference value; the user has a history of solving the same question; and the previous answer was correct.

As shown in the sixth row in the table of FIG. 7A, the database management device 50 determines that the question-solving status has value three if the present answer is correct; the solving time exceeds the reference value; the user has a history of solving the same question; and the previous answer was incorrect.

As shown in the first row in the table of FIG. 7B, the database management device 50 determines that the question-solving status has value three if the present answer is incorrect, and the current value of the user's question-solving status for this question is value four. As shown in the second row in the table of FIG. 7B, the database management device 50 determines that the question-solving status has value minus-one if the present answer is incorrect, and the current value of the user's question-solving status for this question is value three or less. In addition, as shown in the third row in the table of FIG. 7B, the database management device 50 determines that the question-solving status has value two if the present answer is incorrect; the user has no history of solving the same question; and the current value of the question-solving status is null.

As described above, the higher the user's level of proficiency or level of understanding of the question, the greater the value the database management device 50 determines as the question-solving status; the lower the user's level of proficiency or level of understanding of the question, the smaller the value the database management device 50 determines as the question-solving status. The database management device 50 then writes the value in the answer history data.

After causing the database management device 50 to register, in the database 51, the answer history data based on the answer-related data received from the user terminal 10 in S140, the controller 31 subsequently executes a process to obtain a new question data (S150). More specifically, the controller 31 transmits a next-question request command to the question-supply control device to request a next question and obtains a new question data that corresponds to the next question from the question-supply control device 70 (S150).

In S150, the controller 31 transmits the next-question request command along with additional data that the question-supply control device 70 requires to determine the next question. The additional data includes information about the answer, the memo-image data, and the question ID received from the user terminal 10 as the answer-related data in S130. The memo-image data included in this additional data shows the memo entered by the user during the process of solving the question supplied by the user terminal 10 immediately before the next question (that is, previous question). The question ID included in the additional data shows the question ID of this previous question. The answer included in the additional data is the answer of the user to the previous question.

The memo entered during the process of solving the question includes memo of the user before reaching the solution and thus shows characteristics that correspond to the level of proficiency or level of understanding of the user. In the present embodiment, the memo-image data that includes such a characteristic is transmitted to the question-supply control device 70 to cause the question-supply control device 70 to transmit the question data of the next question that corresponds to the level of proficiency or level of understanding of the user.

Subsequent to the execution of S150, the controller 31 transmits the question data of the next question received from the question-supply control device 70 via the network NT2 to the user terminal 10 that transmitted the answer-related data (S160). The controller 31 thereby provides the user terminal 10 with the question data of the next question that is determined based on the memo-image data of the previous question. The question-supply unit 111 in the user terminal 10 receives the question data from the server 30 and causes the display 17 to display the next question based on the received question data.

Subsequent to the execution of S160, the process returns to S130 in which the controller 31 receives the answer-related data corresponding to the question data from the user terminal 10 via the WAN communicator 35. In response to receiving the answer-related data, the controller 31 executes the process from S140 onward again. Although not shown, the controller 31 can stop waiting to receive the answer-related data (S130), or stop the transmission of the question data (S160), and end the process shown in FIG. 5 in response to an end-command input from the user terminal 10, or in response to receiving no response from the user terminal 10 for a given time or longer.

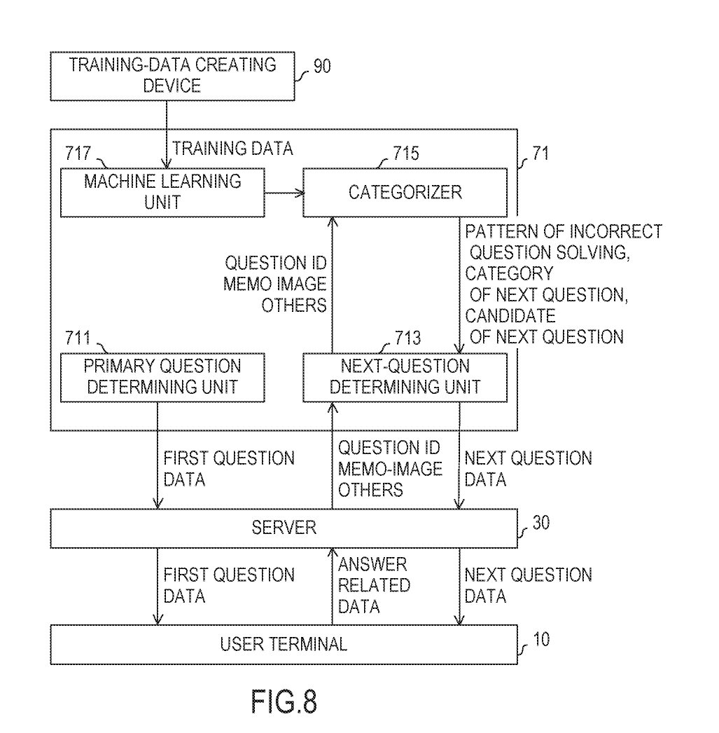

Configurations of the question-supply control device 70 and its processing activities will be explained next with reference to FIG. 4 and FIG. 8. As shown in FIG. 4, the question-supply control device 70 comprises a controller 71, a storage 73, and a communicator 75.

The controller 71 comprises a CPU 71A and a RAM 71B. The CPU 71A executes a process in accordance with a program stored in the storage 73. The RAM 71B is used as a working memory when the CPU 71A executes the process. Hereinafter, the process executed by the CPU 71A will be explained as being executed by the controller 71.

The storage 73 stores various programs and data. The communicator 75 is designed to communicate with the server 30, the database management device 50, and the training-data creating device 90 within the network NT2.

The controller 71 executes a process in accordance with the program stored in the storage 73 to function as a primary question determining unit 711, a next-question determining unit 713, a categorizer 715, and a machine learning unit 717 as shown in FIG. 8.

In response to receiving the primary question request command from the server 30 via the network NT2, the primary question determining unit 711 accordingly determines a question that should be supplied first from the group of questions designated by the user terminals 10 and transmits the question data of the determined question to the server 30. The primary question determining unit 711 can determine the question to be supplied based on the user's answer history data stored in the database 51. The user identification data can be obtained from the server 30 along with request commands.

In response to receiving the next-question request command transmitted from the server 30 via the network NT2 (S150), the next-question determining unit 713 determines the next question pertaining to the previous question in accordance with the request command and additional data and transmits the question data of the determined question to the server 30.

In response to receiving the next-question request command, the next-question determining unit 713 inputs, to the categorizer 715, a set of the question ID, the answer, and the memo-image data of the previous question included in the additional data to obtain output data from the categorizer 715. The next-question determining unit 713 determines the next question to be supplied by the user terminal 10 based on the output data from the categorizer 715.

The output data from the categorizer 715 includes information for determining a next question suitable for the user. The output data of the categorizer 715 comprises at least one of, for example, information of a pattern of incorrect question solving in the previous question (that is, a pattern of how the previous question is incorrectly solved); information of categories for the next question that is relevant to the incorrect question solving in the previous question; and information of a list of next question candidates.

In response to the input data that includes a set of the question ID; the answer; and the memo-image data of the previous question, the categorizer 715 outputs data that include at least one of information of a pattern of incorrect question solving in the previous question; information of categories for the next question that is relevant to the incorrect question solving in the previous question; and information of a list of next question candidates as a result of machine learning on training data by the machine learning unit 717.

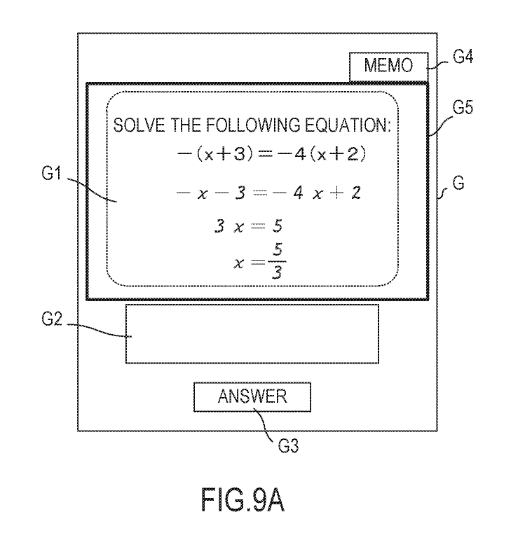

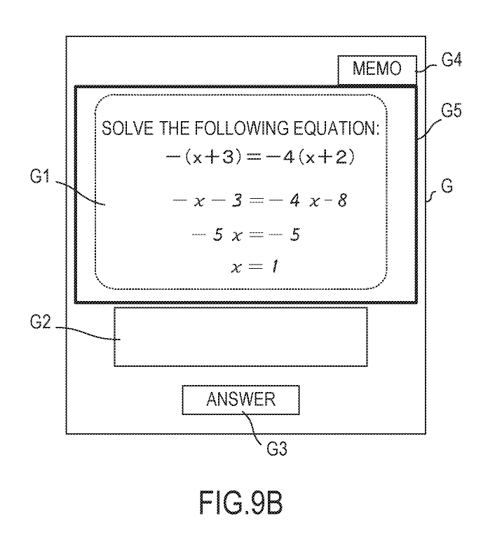

A first and second example answers to a question of equation are shown in FIG. 9A and FIG. 9B as examples. The question of equation shown in FIG. 9A and FIG. 9B is the same as the question of equation shown in FIG. 3A, which is “Solve the following equation: −(x+3)=−4(x+2)”. The first example answer shown in FIG. 9A shows that the user obtained an answer that is x=5/3. Since the correct answer is X=−5/3, the first example answer is incorrect. The memo-image data entered by the user, which shows the process of solving the equation, explains that this incorrectness is caused by an error related to the distributive law. Meanwhile, the second example answer shown in FIG. 9B shows that the user obtained an answer that is x=1, which is incorrect. The memo-image data entered by the user, which shows the process of solving the equation, explains that this incorrectness is caused by an error related to transposition.

Analysis of the memo-image data as described above can help to identify the cause that led the user to obtain an incorrect answer to the question. A question suitable for the next question can be determined based on the cause of the incorrect answer with a help of a teacher's experience. Based on such a principle, the training data is created manually, and the aforementioned categorizer 715 is created by machine learning on the training data in the present embodiment.

The first example of the categorizer 715 is a case in which the categorizer 715 outputs the list of next question candidates. The list of candidates enumerates the question ID of next question candidates.

In this case, the next-question determining unit 713 may randomly select one question from the list of next question candidates, which is obtained from the categorizer 715, and determine the selected question as the next question, and then transmit the question data of the determined next question to the server 30 as the data responding to the next-question request command. The next-question determining unit 713 may also select one question as the next question from the list of next question candidates in accordance with a predefined non-random selection rule.

For example, the next-question determining unit 713 may preferentially select a question that has not been supplied from the user terminal 10 as the next question. The categorizer 715 may output, as the output data, a single question ID that corresponds to a next question instead of the list of next question candidates. In this case, the next-question determining unit 713 may determine the question corresponding to the question ID, which is indicated in the output data, as the next question and transmits the question data to the server 30.

The second example of the categorizer 715 is a case in which the categorizer 715 outputs the category of the aforementioned next question. In this case, the next-question determining unit 713 may randomly select one question from questions that belong to the category indicated by the output data of the categorizer 715, determine the selected question as the next question, and then transmit the question data of the determined next question to the server 30.

In this case, each question data may be labelled to indicate the category of the question. The next-question determining unit 713 may refer to the label to determine the next question from the questions that belong to the category indicated by the output data from the categorizer 715. Similarly to the first example, the next-question determining unit 713 may also determine the next question in accordance with a predefined non-random selection rule.

The third example of the categorizer 715 is a case in which the categorizer 715 outputs the aforementioned pattern of incorrect question solving. In this case, the next-question determining unit 713 may randomly select one question from the questions that suit the pattern of incorrect question solving, which is indicated in the output data from the categorizer 715, and determine the selected question as the next question, and then transmit the question data of the determined next question to the server 30.

In this case, a list of questions suitable for the next question may be prepared for each previous question and each pattern of incorrect question solving, and each list may be stored in the storage 73. The next-question determining unit 713 may determine the next question based on the “list of suitable questions for the next question” prepared for each previous question and each pattern of incorrect question solving.

The fourth example of the categorizer 715 is a case in which the categorizer 715 outputs the list of next question candidates and the category of the next question. In this case, if the number of the candidates of the next question indicated by the output data from the categorizer 715 is greater than a given number, the next-question determining unit 713 may determine, as the next question, a question that is selected from the list of candidates randomly or in accordance with a predefined rule. If the number of the candidates of the next question indicated by the output data from the categorizer 715 is less than the given number, the next-question determining unit 713 may determine, as the next question, a question that is selected from questions that belong to the category indicated by the output data from the categorizer randomly or in accordance with the predefined rule. The next-question determining unit 713 may transmit the question data of thus determined next question to the server 30.

The machine learning unit 717 creates and updates the categorizer 715 by populating a specified machine learning algorithm with a collection of training data, which is input-output samples of the categorizer 715. Creating the categorizer 715 corresponds to, for example, learning values for coefficients and completing a function with a supply of the collection of training data, which is pairs of input and output, to the function that include undetermined coefficients. Various algorithms are known as machine learning algorithms. In the present embodiment, any choice of machine learning algorithms can be used to create the categorizer 715.

The training data used to create the aforementioned first example of the categorizer 715 is a sample pair of input and output in which the input includes <the question ID, the answer, and the memo-image data>; and the output includes the list of next question candidates. The pair of input and output means a pair of input and output data. The training data used to create the second example of the categorizer 715 is a sample pair of input and output in which the input includes <the question ID, the answer, and the memo-image data>; and the output includes the category of the next question. The training data used to create the third example of the categorizer 715 is a sample pair of input and output in which the input includes <the question ID, the answer, and the memo-image data>; and the output includes the pattern of incorrect question solving. The training data used to create the fourth example of the categorizer 715 is a sample pair of input and output in which the input includes <the question ID, the answer, and the memo-image data>; and the output includes <the category of the next question, and the list of next question candidates>. The expression <A, B, C> means a combination of A, B, and C.

To set the output of the categorizer 715 to <the pattern of incorrect question solving, the category of the next question, and the list of next question candidates>, a sample pair of input and output is prepared as the training data, in which the input includes <the question ID, the answer, and the memo-image data> and the output includes <the pattern of incorrect question solving, the category of the next question, and the list of next question candidates>. The categorizer 715 is created and updated by machine learning based on the training data.

The machine learning unit 717 uses a collection of the training data that is stored in the storage 73 and creates the categorizer 715, for example, periodically, or every time training data is added, or every time a command from the training-data creating device 90 is received. Recreating the categorizer 715 corresponds to updating the categorizer 715.

The training data is added to the storage 73 through the training-data creating device 90. As shown in FIG. 4, the training-data creating device 90 comprises a controller 91, a storage 93, a communicator 95, a display 97, and an input 99.

The controller 91 comprises a CPU 91A and a RAM 91B and integrally controls the training-data creating device 90. The CPU 91A executes a process in accordance with a program stored in the storage 93. The RAM 91B is used as a working memory when the CPU 91A executes the process. Hereinafter, the process executed by the CPU 91A will be explained as being executed by the controller 91.

The storage 93 stores various programs and data. The communicator 95 is coupled to the network NT2 and thus communicatively couples the training-data creating device 90 to the server 30, the database management device 50, and the question-supply control device 70.

The display 97 displays various windows, including a creating window for the training data, for an operator in the back end. The display 97 comprises, for example, a liquid crystal display. The input 99 receives an input manipulation from the operator and inputs a corresponding manipulation signal to the controller 91. The input 99 may comprise an input device, for example, a keyboard, a pointing device, and a touch panel.

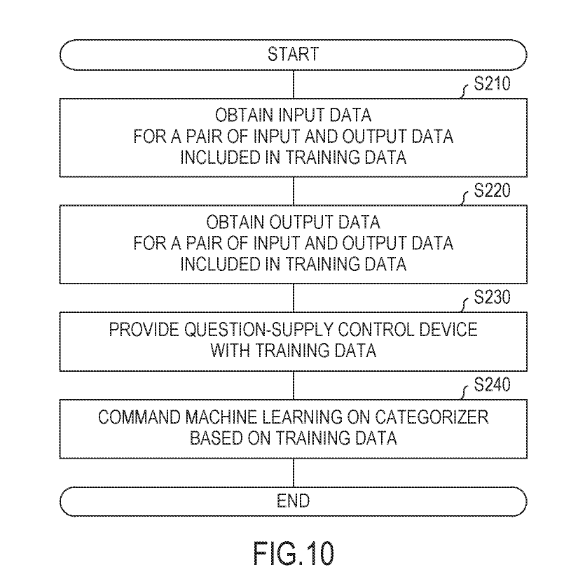

The controller 91 starts a process of creating the training data as shown in FIG. 10 in accordance with a command from the operator through the input 99. Once the process begins, the controller 91 obtains input data for the pair of input and output data that is necessary for creating the training data (S210). The format of the input data matches the categorizer 715; the input data includes, for example, <the question ID, the answer, and the memo-image data>.

The training-data creating device 90 may comprise a function to create the memo-image data equivalent to that of the user terminal 10. Alternatively, the training-data creating device 90 may comprise a function to obtain, from the database 51 or other external devices, data of <the question ID, the answer, and the memo-image data> as the training data. This obtaining process of the input data may be executed in accordance with a command from the operator through the input 99.

The controller 91 subsequently obtains the output data that corresponds to the input data from the operator through the input 99. The operator can manually input the output data through the input 99. The output data is a pattern of incorrect question solving, a category of the next question, a list of next question candidates, or a combination of the above (S220). The operator can input the output data that is subjectively considered “appropriate to pair with the input data” through the input 99.

The controller 91 subsequently creates the training data that includes a set of the input data obtained in S210 and the output data obtained in S220, and stores this training data in the storage 73 in the question-supply control device 70 (S230). In other words, the controller 91 supplies the created training data to the question-supply control device 70 through the network NT2 (S230).

The controller 91 may execute the process from S210 to S230 for two or more sets of training data in parallel or in serial. The controller 91 subsequently inputs, to the machine learning unit 717 in the question-supply control device 70 though the network NT2, a command to learn the categorizer 715 based on the collection of the training data, including the added training data, that is accumulated in the storage 73 (S240). This causes the machine learning unit 717 in the question-supply control device 70 to create or update the categorizer 715. The controller 91 repeatedly executes such a process of creating the training data in accordance with a command input from the input 99 by the operator. As a consequence, the categorizer 715 is repeatedly updated and thus functions productively in determining the next question.

According to the aforementioned study-support system 1 in the present embodiment, the question-supply unit 111 in the user terminals 10 supplies the question for learning to the user through the display 17. Also, the memo-receiving unit 115 creates the memo-image data, which is an electronic memo, in response to the memo entry by the user through the input 19. In addition, the next-question determining unit 713 in the question-supply control device 70 determines, based on the memo-image data created in the process of solving the question, the next question to be supplied from the question-supply unit 111 and provides the user terminals 10 with the question data corresponding to the next question through the server 30.

As mentioned above, the memo-image data includes the memo entered by the user during the process of solving the question. In some cases, as shown in FIG. 9A and FIG. 9B, the memo-image data includes the answer the user obtained. This memo, entered by the user during the process of solving the question, shows characteristics that correspond to the level of proficiency or level of understanding of the user. For example, the memo shows characteristics of an incorrect question solving style that correspond to the level of proficiency or level of understanding of the user.

According to the present embodiment, it is possible to build the study-support system 1 that can supply a suitable question that corresponds to the level of proficiency and level of understanding of the user based on the memo-image data. In other words, the present embodiment can provide the study-support system 1 that allows the user to learn effectively.

Particularly in the present embodiment, in response to the input from the memo-image data into the categorizer 715, the next question is determined based on the output of the categorizer 715. The categorizer 715 outputs at least one of information of the pattern of incorrect question solving in the previous question; information of the category of the next question; and information of the list of next question candidates. Such information directly or indirectly represents questions that should be candidates of the questions to be supplied. According to the present embodiment, a question that is suitable for the user can be flexibly supplied as the next question based on the output of the categorizer 715.

Nevertheless, the present disclosure is not limited to the aforementioned embodiment and may have various modes. For example, the output of the categorizer 715 may be data that shows a single next question (a single question that should be supplied).

In the aforementioned embodiment, the input to the categorizer 715 are <the question ID, the answer, and the memo-image data>. Nevertheless, the categorizer 715 may receive an input of data such as the solving time, and whether the answer was right or wrong in addition to data of the question ID, the answer, and the memo-image data. That is, the input to the categorizer 715 may be set to <the question ID, the answer, right or wrong answer, the solving time, and the memo-image data>. Such an increase in the input data to the categorizer 715 can help to determine the next question to be more suitable for the level of understanding and level of proficiency of the user.

In contrast, the input to the categorizer 715 may also be set to <the question ID, and the memo-image data> without including data of the answer, the solving time, and whether the answer was right or wrong. Even with a reduced input of data to the categorizer 715, the memo-image data still shows characteristics that correspond to the level of understanding and level of proficiency of the user; thus the next question can still be determined appropriately.

Additionally, the input to the categorizer 715 may also be set to <the question ID, right or wrong answer, and the memo-image data>. In other words, information of whether the answer was right or wrong may be used in place of the information of the answer. As another example, the input to the categorizer 715 may also be set to <the question ID, the answer, the solving time, and the memo-image data>, or <the question ID, the answer, the status value for the answer, and the memo-image data>. The “other” data, which is shown in FIG. 8 as the input to the categorizer 715, may be understood as one or more of the answer, whether the answer was right or wrong, the solving time, and the status value for an answer; or, the “other” data need not exist.

The input to the categorizer 715 can be defined by having the question ID and the memo-image data as the basis, and combining the basis with various parameters associated with the level of understanding and level of proficiency of the user. In addition, the categorizer 715 can receive an input of the memo-image data that has not undergone the text recognition process, which is, for example, memo-image data that includes image information or chronological positional information of the penstrokes but does not include text information.

In this case, the categorizer 715 can use the image information or chronological positional information of the penstrokes included in the memo-image data as feature values to determine the output without converting such information into text information. More specifically, the categorizer 715 may directly input the image information (for example, bitmap image information) or the chronological positional information of the penstrokes included in the memo-image data to determine the output without running the text recognition process on the memo-image data.

Similarly, the machine learning unit 717 may directly populate the specified machine learning algorithm with the image information or chronological positional information of the penstrokes included in the memo-image data without running the text recognition process. Positions, speed, history of deletion, and so forth of the penstrokes include more information associated with the conception of the user. For example, a user who easily solves the question and a user who feels difficulty in solving the question have different speeds of writing. In addition, a memo written in small letters at a corner of the memo window and a memo written in large letters at the center of the memo window are weighed differently by the user. Thus, the next question can be determined even more appropriately in the example in which machine learning is done without converting the information about the penstrokes into texts. Nevertheless, the categorizer may be designed without using machine learning.

In the aforementioned embodiment, cooperation between the user terminal 10, the server 30 and other backend devices (50, 70, and 90) helps to appropriately control the supply of questions in the user terminal 10. Nevertheless, in this study-support system 1, functions of two or more elements may be integrated to one element; functions of one element may be divided to two or more elements. Also, functions of one element may be included in other elements.

For example, the user terminal 10 may comprise a function to store sets of the question data in the storage 13 and to select the question data of the next question from the sets of the question data based on the output data of the categorizer 715. In other words, the user terminal 10 may comprise the function of the next-question determining unit 713. Similarly, the user terminal 10 may also comprise the categorizer 715. In addition, functions of the server 30, the database management device 50, the question-supply control device 70, and the training-data creating device 90 may be integrated in one device.

Any and all modes that are encompassed in the technical ideas that are defined by the languages in the scope of the claims are embodiments of the present disclosure.

1. A study-support system comprising:
a question-supply unit configured to supply a first question to a user through a display;
a creating unit configured to create an electronic memo in response to a memo entry by the user through an input device that is integrated with or attached to the display; and
a determining unit configured to determine a second question to be supplied based on the electronic memo including a memo entered by the user during a process of solving the first question,
the question-supply unit supplying the second question that is determined in the determining unit.

2. The study-support system according to claim 1, wherein
the determining unit determines the second question such that a different question is supplied afresh from the question-supply unit depending on differences in the process of solving the first question.

3. The study-support system according to claim 1, wherein the determining unit inputs, to a categorizer, the electronic memo along with question identification data of the first question and determines the second question based on an output from the categorizer; and
in response to the input of the electronic memo and the question identification data, the categorizer outputs target-question information pertaining to the second question or pertaining to a candidate of the second question a question.

4. The study-support system according to claim 3, wherein the categorizer is a machine learning-based categorizer.

5. The study-support system according to claim 3, wherein
the determining unit also inputs, to the categorizer, at least one of information that shows an obtained answer to the first question or information that shows whether the obtained answer was right or wrong; and
the categorizer outputs the target-question information based on a set of input information that comprises the electronic memo and the question identification data, and at least one of the information that shows an obtained answer to the first question or the information that shows whether the obtained answer was right or wrong.

6. The study-support system according to claim 3, wherein
the determining unit also inputs, to the categorizer, at least one of information that shows solving time, which is a duration of time taken by the user to solve the first question, or information that shows a level of proficiency or a level of understanding of the user; and
the categorizer outputs the target-question information based on a set of input information that comprises the electronic memo and the question identification data, and at least one of the information that shows solving time or the information that shows a level of proficiency or a level of understanding of the user.

7-16. (canceled)

17. A server comprising:
an obtaining unit configured to obtain an electronic memo that is created based on a memo entry by a user in an electronic device for supplying a first question to the user, the electronic memo including a memo entered by the user during a process of solving the first question;
a determining unit configured to determine a second question to be supplied by the electronic device based on the electronic memo obtained by the obtaining unit; and
an information supplying unit configured to transmit, to the electronic device, information of the second question determined in the determining unit.

18. The server according to claim 17, wherein
the electronic device supplies the first question to the user through a display and creates the electronic memo based on the memo entry by the user through an input device that is integrated with or attached to the display.

19. The server according to claim 17, wherein
the determining unit inputs, to a categorizer, the electronic memo along with question identification data of the first question and determines the second question based on an output from the categorizer; and
in response to the input of the electronic memo and the question identification data, the categorizer outputs target-question information pertaining to the second question or pertaining to a candidate of the second question.

20. A method performed by a processor, the method comprising:
supplying a first question to a user through a display;
creating an electronic memo based on a memo entry by the user through an input device that is integrated with or attached to the display; and
determining a second question to be supplied to the user based on the electronic memo that includes a memo entered by the user during a process of solving the first question.

21. The method according to claim 20, wherein
the determining includes determining the second question such that a different question is supplied afresh depending on differences in the process of solving the first question.

22. The method according to claim 20, wherein the determining further includes:
inputting, to a categorizer, the electronic memo along with question identification data of the first question; and
determining the second question based on an output from the categorizer;
wherein, in response to the input of the electronic memo and the question identification data, the categorizer outputs target-question information pertaining to the second question or pertaining to a candidate of the second question.

23. The method according to claim 22, wherein the categorizer is a machine learning-based categorizer.

24. The method according to claim 22, wherein
the inputting further includes inputting, to the categorizer, at least one of information that shows an obtained answer to the first question or information that shows whether the obtained answer was right or wrong, and
the categorizer outputs the target-question information based on a set of input information that comprises the electronic memo and the question identification data, and at least one of the information that shows an obtained answer to the first question or the information that shows whether the obtained answer was right or wrong.

25. The method according to claim 22, wherein
the inputting further includes inputting, to the categorizer, at least one of information that shows solving time, which is a duration of time taken by the user to solve the first question, or information that shows a level of proficiency or a level of understanding of the user; and
the categorizer outputs the target-question information based on a set of input information that comprises the electronic memo and the question identification data, and at least one of the information that shows solving time or the information that shows a level of proficiency or a level of understanding of the user.

26. A non-transitory computer readable medium storing instructions for causing a processor to perform a method according to claim 20.
